(19) United States
(12) Patent Application Publication
(10) Pub. No.: US 2012/0209629 A1
(43) Pub. Date: Aug. 16, 2012

(54) SYSTEMS AND METHODS FOR PROVIDING AN ASSET ALLOCATION WHOLE LIFE INSURANCE OPTION WITH A PREMIUM FUNDING VEHICLE

(75) Inventors: Michael J. Gordon, New York, NY (US); Michelle O. Richter, Stamford, CT (US); Paul C. McClung, New York, NY (US)

(73) Assignee: New York Life Insurance Company, New York, NY (US)

(21) Appl. No.: 13/025,043

(22) Filed: Feb. 10, 2011

(51) Int. Cl. G06Q 40/00

(52) U.S. Cl. 705/4

(57) ABSTRACT

The present invention provides methods, computer media and systems for providing a hybrid life insurance and non-life insurance investment product for an individual. Embodiments of the methods, computer media and systems include obtaining an initial investment amount for an investment product comprising a life insurance investment component and a non-life insurance investment component and a face amount of the life insurance investment component, calculating a premium payment amount for the life insurance investment component, determining a payment schedule for the premium payment amount, allocating a portion of the initial investment amount to the life insurance investment component and allocating a portion of the initial investment amount to the non-life insurance investment component, and presenting, based at least in part on the allocations of the initial investment amount to the life insurance investment component and to the non-life insurance investment component, the premium payment amount and the payment schedule, the life insurance investment component and the non-life insurance investment component as a combined investment product for an individual in a singular transaction.

### RELATED APPLICATIONS

The present application relates to a co-pending commonly owned U.S. patent application entitled Method and System for Providing a Customizable Insurance Policy, Ser. No. 11/391,876, and a co-pending commonly owned U.S. patent application entitled Methods and Systems for Insurance Investment Product Decision Modeling, Ser. No. 12/403,474, both of which are hereby fully incorporated herein.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

Embodiments of the invention described herein generally relate to providing hybrid insurance and investment product to customers. More specifically, embodiments of the present invention are directed towards methods, systems and computer media for allowing a customer to invest in both an insurance investment and a non-insurance investment.

### BACKGROUND OF THE INVENTION

Currently, investors have a variety of options for investment and planning for future events. Such options include various types of insurance, such as such as life insurance, health insurance, disability insurance or long-term care insurance. One type of life insurance is whole life insurance, which provides insurance protection over one's entire lifetime. Whole life insurance may further be a limited payment or paid up life insurance, where the entire face amount of the policy is payable at death but premiums are only due for a limited number of years, after which time the policy becomes paid up, such as described in U.S. patent application Ser. No. 11/391,876. Investment options also include various types of savings plans, stock portfolios, mutual fund accounts and the like. The current state of the art requires an investor to seek out and invest in a plurality of separate products in multiple transactions in order to obtain the benefits of both insurance products as well as traditional asset products. For example, an investor may maintain an investment portfolio at a brokerage, an insurance policy with an insurance provider, and various other savings, checking, and other investment accounts at other institutions. In addition to providing separate principal amounts to these various accounts, the investor is additionally required to manage the accounts separately, and pay separate fees and charges for the various accounts. Further, periodic premium payments for insurance policies can have various disadvantages to the insured including the possibility of non-payment if the customer does not have adequate funds to pay the higher premium associated with whole life insurance policies, foregoing other methods of investing funds so as to ensure such funds are available for the premiums, or facing potential risk of loss of principal amounts needed to pay premiums if the funds to be allocated to such premiums are invested in stocks or risk based investments. Thus there is need in the art for a hybrid insurance and investment product that allows an insured or investor to obtain in a single transaction an insurance policy and an investment product which provides potential for better investment returns, less risk and the benefits of insurance. Furthermore, there is a need in the art for a hybrid insurance and investment product that allows an insured to benefit from payment of a discounted present value of future premium payments.

### SUMMARY OF THE INVENTION

In some embodiments, the present invention overcomes the above-noted and other shortcomings of the prior art by providing novel and improved methods, computer media and systems for providing a hybrid life insurance and non-life insurance investment product for an individual.

In one aspect of the invention, the method includes obtaining an initial investment amount for an investment product comprising a life insurance investment component, such as whole life, universal life, variable universal life, term life or the like, and a non-life insurance investment component, such as a mutual fund investment, exchange traded fund investment, individual stock or equity investments, or the like, obtaining a face amount of the life insurance investment component, electronically calculating, using a processing device, a premium payment amount for the life insurance investment component, determining a payment schedule for the premium payment amount, allocating a portion of the initial investment amount to the life insurance investment component, allocating a portion of the initial investment amount to the non-life insurance investment component, and presenting, based at least in part on the allocations of the initial investment amount to the life insurance investment component and the non-life insurance investment component, the premium payment amount and the payment schedule, the life insurance investment component and the non-life insurance investment component as a combined investment product for an individual in a singular transaction.

In some embodiments, the payment schedule for the premium payment amount comprises a single payment, or the single payment of the premium payment amount comprises a payment amount for an initial period of time and a payment amount for a future period of time calculated based on a discounted present value of future premium payments. In other embodiments, electronically calculating the premium payment amount further comprises calculating a discount to be applied to the premium payment amount based at least in part on a guaranteed interest value. In still further embodiments, the life insurance investment component comprises a life insurance group certificate.

In another aspect of the invention, a computer program product for use in a computer system that executes program steps recorded on one or more computer readable media to perform a method for providing a hybrid insurance and investment product is provided. In an example of such an embodiment, the computer program product comprises one or more computer readable media, and one or more computer programs of computer readable instructions executable by the computer system to perform method steps comprising obtaining an initial investment amount for an investment product comprising a life insurance investment component and a non-life insurance investment component, obtaining a face amount of the life insurance investment component, electronically calculating, using a processing device, a premium payment amount for the life insurance investment component, determining a payment schedule for the premium payment amount, allocating a portion of the initial investment amount to the life insurance investment component, allocating a portion of the initial investment amount to the non-life insurance investment component, electronically storing data representing the portion of the initial investment amount allocated to the life insurance investment component, the portion of the initial investment amount allocated to the non-life insurance investment component, the premium payment amount and the payment schedule, presenting the life insurance investment component and the non-life insurance investment component as a combined investment product for an individual in a singular transaction.

In another aspect of the invention, a system for providing a hybrid life insurance and non-life insurance investment product for an individual is provided, including a user interface effective to obtain an initial investment amount for an investment product comprising a life insurance investment component and a non-life insurance investment component and a face amount of the life insurance investment component, a data storage device operative with the user interface and effective to store the initial investment amount for an investment product comprising a life insurance investment component and a non-life insurance investment component, a face amount of the life insurance investment component, data representing an allocated portion of the initial investment amount allocated to the life insurance investment component and an allocated portion of the initial investment amount allocated to the non-life insurance investment component, a premium payment amount and a payment schedule, and a processor operative with the user interface and data storage device effective to calculate a premium payment amount for the life insurance investment component, determine a payment schedule for the premium payment amount, allocate a portion of the initial investment amount to the life insurance investment component, allocate a portion of the initial investment amount to the non-life insurance investment component, and present the life insurance investment component and the non-life insurance investment component as a combined investment product for an individual in a singular transaction.

The foregoing and other embodiments of the invention are described in the herein description of the invention.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates an example of a system for providing a hybrid life insurance and non-life insurance investment product for an individual, according to one embodiment of the present invention;

FIG. 2 illustrates an example of a method for providing a hybrid life insurance and non-life insurance investment product for an individual, according to one embodiment of the present invention;

FIG. 3 illustrates an example of a method for providing a premium funding vehicle according to one embodiment of the present invention; and

FIG. 4 illustrates an example of a method for providing a premium funding vehicle according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that numerous embodiments are described herein which are not intended to limit the scope of the present invention, and further that other embodiments may be utilized and structural changes may be made without departing from the scope of the present invention.

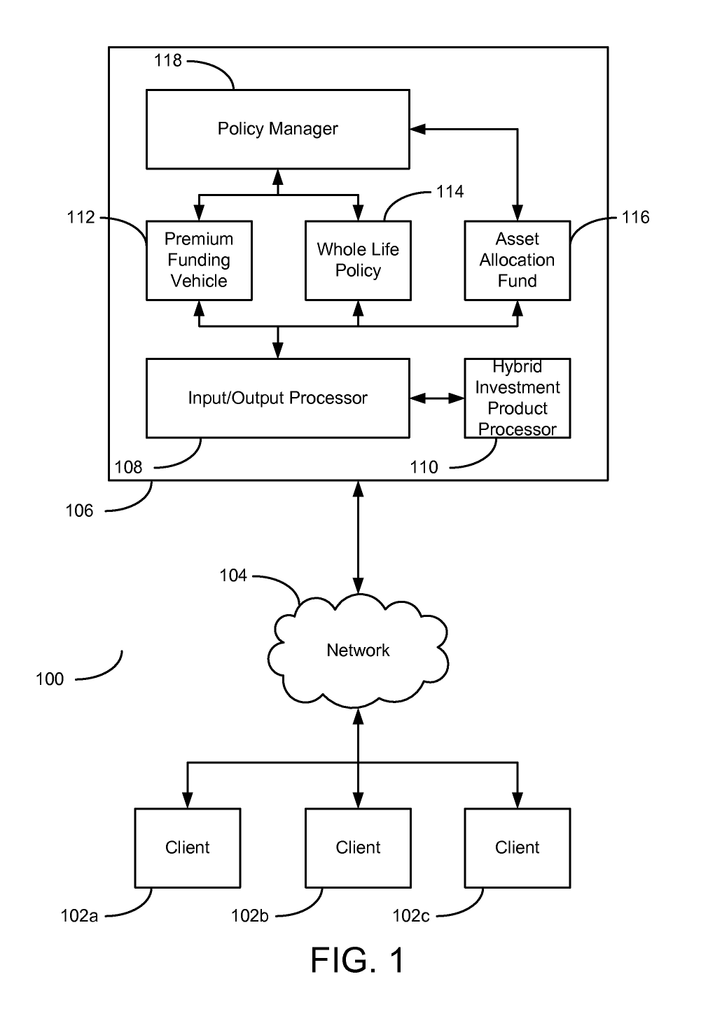

FIG. 1 illustrates one example of a system for providing a hybrid life insurance and non-life insurance investment product for an individual, with a premium funding vehicle, according to one embodiment of the present invention. According to the embodiment, FIG. 1 illustrates a plurality of clients 102a, 102b, 102c which are in communication with an insurance provider 106 through a network 104. Clients 102a-c may comprise user interfaces, usable by, for example, an insurance agent, a prospective or current insured, a prospective or current investor, an insurance provider, an investment advisor, or other users. In an alternative embodiment, 106 comprises a fund manager, such as a mutual fund manager, or provider, or in still further embodiments, is another entity that facilitates the providing of a hybrid life insurance and non-life insurance investment product to an individual.

In one embodiment, clients 102a, 102b, 102c enable the users to connect to the insurance provider 106 via a website or other computer software and hardware. For example, insurance provider 106 may provide a user interface through clients 102a-c to allow users to participate in various insurance and investment opportunities. In an embodiment, a prospective insured would communicate in person or telephonically with an insurance agent who is using one of clients 102a-c to communicate with the insurance provider 106 and input insurance and investment preferences being obtained from the prospective insured. In an alternative embodiment, a prospective insured or investor communicates directly with the insurance agent or the insurance provider, or other entity, in order to facilitate the methods and systems contemplated under the present invention.

In the example embodiment of FIG. 1, insurance provider 106 comprises an input/output processor 108 operative to obtain data input via the user interfaces of clients 102a-c, handle incoming data requests from and outgoing data transmissions to clients 102a-c, or other functions described in connection with the present invention. In the illustrated embodiment, input/output processor 108 is operative to receive requests to establish the new hybrid investment product described herein, and in other embodiments is operative to perform functions relating to other insurance policies or investment products. In an embodiment, input/output processor 108 is operative to enable users to view, modify, or conduct transactions relating to a prospective hybrid investment product or relating to an existing hybrid investment product. By way of example and not limitation, a user of client 102a, 102b, 102c may navigate to a web site containing an enrollment form provided by the insurance provider 106. In this example, the user fills out an online form and transmits the data to the input processor 108 which performs a plurality of processing operations relating to the data from the form. Such data includes, in some embodiments, an initial investment amount for an investment product comprising a life insurance investment component and a non-life insurance investment component, a face amount of the life insurance investment component, an allocation selection representing an allocated portion of the initial investment amount allocated to the life insurance investment component and an allocated portion of the initial investment amount allocated to the non-life insurance investment component, a premium payment amount, a premium payment schedule, or a selection of an option to enable or disable a premium funding vehicle. Such data also includes, in some embodiments, information relating to a prospective insured or investor, such as name, age, employment status, health data, or other nature of data relating to eligibility for a hybrid investment product. In embodiments where the client is operative to view, modify or otherwise access data relating to an existing investment product, data input may include passwords or other security features. Exemplary processing applications including determining eligibility of a prospective insured or investor, as well as determining or recommending an appropriate investment option are discussed further herein.

In an embodiment, input/output processor 108 may further comprise a data storage device effective to store data used or maintained in connection with the present invention, or such stored or maintained data may be stored or maintained in a data storage device distinct or separate from input/output processor 108.

In the example embodiment of FIG. 1, a hybrid investment product processor 110 is operative to interact directly with input/output processor 108 and indirectly with clients 102a-c via respective user interfaces. Any number of other system configurations are contemplated and within the scope of the present invention. In the illustrated embodiment, hybrid investment product processor 110 is operative to calculate a premium payment amount for the life insurance investment component of the hybrid investment product, determine a payment schedule for the premium payment amount, allocate a portion of the initial investment amount to the life insurance investment component, allocate a portion of the initial investment amount to the non-life insurance investment component, and present to the input/output processor 108, for further presentation to clients 102a-c, the life insurance investment component and the non-life insurance investment component as a combined investment product for an individual in a singular transaction.

In an embodiment, in response to a request for a hybrid investment product, hybrid investment product processor 110 determines the face value of a life insurance policy to comprise a life insurance investment component of the hybrid investment product contemplated by the invention, which may be whole life insurance or custom whole life insurance, such as described in U.S. patent application Ser. No. 11/391,876, or other nature of insurance such as insurance products which include an accumulation or investment aspect. The insurance may issue as an individual policy or group certificate, and may have other variations as are known to those of skill in the art of insurance products. The face value of the example whole life insurance is, in an embodiment, selected by a prospective insured as a set value, or is calculated by input/output processor 108 or hybrid investment product processor 110 as a percentage of an initial investment amount supplied by the prospective insured or other user using client device 102a-c, or using a recommendation engine or system, such as that described in U.S. patent application Ser. No. 12/403,474. In an example embodiment, hybrid investment product processor 110 determines that for a $100,000 initial investment amount, an appropriate face value for the insurance investment component would be $25,000. The hybrid investment product processor 110 then calculates an annual premium which in the example is based on a defined pay period. For instance, for the insurance investment component comprising a whole life insurance policy with a $25,000 face value, hybrid investment product processor 110 determines that the annual premium will be $2,000 with a pay period of 12 years for a total premium of $24,000. In an embodiment, the remainder of the initial investment amount of $100,000 is allocated by hybrid investment product processor 110 to the non-life insurance investment component in the amount of $76,000. In this or an alternative embodiment, the non-life insurance investment component is further allocated among asset types such as, by way of example and not limitation, to 60% equities and 40% fixed income assets.

In a further embodiment, a payment schedule is determined for payment of the premium for the life insurance component of the hybrid investment product. In some embodiments, the payment schedule will be annual, or another periodic interval, such as in the example of an annual premium for 12 years of $2,000 per year. In another embodiment, the payment schedule for the premium will comprise a single payment. Thus, for instance, if the total premium for the life insurance component is $24,000, that amount will be paid to the provider of the insurance in a single payment. In a still further embodiment, the single payment of the premium payment amount will be calculated at a discounted rate, based on the discounted present value of future premium payments. A further variation of the single payment is provided, wherein the single payment of the premium payment amount comprises both a payment amount for an initial period of time, such as the first year of the policy, and a payment amount for a second, future period of time, such as the next 11 years for a policy where the premium is set to be paid up after 12 years. In this example, the calculation of the premium payment amount includes calculating a discount to be applied to the premium payment amount based at least in part on a guaranteed interest value to be applied to payment of the premiums for the policy. Thus, in one example, a prospective insured with $100,000 to invest completes a questionnaire, either on-line or otherwise, and is recommended a whole life group insurance policy with a $25,000 face value, and a non-life insurance asset allocation of 60% equities and 40% fixed income. An annual premium for the whole life insurance policy is $2,000 for 12 years, for a total premium cost of $24,000. In such an example, the prospective insured's initial investment is allocated as follows:
a) $2,000 applied to pay the first year of premium for the whole life insurance policy with a face value of $25,000;
b) $18,500 applied to a premium funding vehicle to meet the premium payments required for the whole life insurance policy in years two to twelve, comprised of the present value of the future premiums discounted at a guaranteed crediting rate;
c) $79,500 into a mutual fund account allocated 60% equities and 40% fixed income.
   It is noted that in an embodiment, the whole life cash value and premium funding vehicle may be treated as part of an investor's fixed income allocation and in such a case the foregoing investment aspect (c) of $79,500 could be allocated at 75% equities and 25% fixed income to maintain an overall asset allocation of 60% equities and 40% fixed income. In the example, during the premium payment period for the whole life insurance, the premium funding vehicle provides automatic, guaranteed recurring premium payments for the whole life insurance policy. The prospective insured invests the full present value of the future premium payments into the premium funding vehicle fund and the fund will earn a guaranteed crediting rate, in this case of 3%, as well as excess interest crediting based on an additional calculation such as used in providing the dividend rate declared for cash value whole life insurance policies.

In an embodiment such as the above described system, the prospective insured using a computer, such as clients 102a-c (which could also be a PDA, mobile phone, etc.), specifies the amount to be invested (e.g., $100,000). In some embodiments, the prospective insured's preferences for an initial investment amount could be provided indirectly through an insurance agent, investment provider, or other intermediary as previously described. Once the initial investment amount is obtained, in various embodiments, the life insurance component, non-life insurance investment component, premium amount and term and non-life insurance allocation can be presented to the prospective insured or investor as a recommendation or chosen by the prospective insured. In some examples, the choices made by the prospective insured or investor will result in parameters being set by the provider of the hybrid investment product. For instance, the provider in some cases would specify a required premium, or specify the maximum guaranteed interest to be credited to the premium funding vehicle or the like. In some embodiments, the provider specifies other parameters for the hybrid investment product, such as permitted issue age (e.g., 20-65 years), whether riders will or will not be permitted, whether an existing policy or investment product may convert to the hybrid investment product, whether the hybrid product may be used in the context of a qualified plan, minimum or maximum face amounts for the insurance investment component, whether commissions will be taken and the process for the same, and how and when pay outs on the hybrid product may be made (e.g., limited prior to the life insurance policy being paid up, etc.). Numerous variations are possible and contemplated as within the scope of the invention, as would be understood by one of skill in the art.

In some embodiments, the hybrid investment product would be offered such that after determining the proper allocation of funds, input/output processor 108 would be in communication with a module, program, processor or data storage device responsible for processing or storage of data concerning the premium funding vehicle 112 such as previously described, a module, program, processor or data storage device responsible for processing or storage of data concerning the life insurance component or policy 114, and a module, program, processor or data storage device responsible for processing or storage of data concerning the non-life insurance investment, such as asset allocation fund 116. In the illustrated embodiment, 112, 114, and 116 comprise combinations of hardware or software operative to process applications, determine eligibility, provide access to data concerning prospective or existing hybrid product components, or perform the allocations and calculations herein described.

In an embodiment, premium funding vehicle module 112 and whole life policy module 114 are coupled with a policy manager module 118. In the illustrated embodiment, policy manager module 118 stores information regarding insured or investor accounts. For example, policy manager module 118 includes a plurality of database structure operative to store account information as well as cross references to the location of the funds allocated or to be allocated to the account. In addition to being coupled to premium funding vehicle module 112 and whole life policy module 114, policy manager module 118 is further coupled to asset allocation fund module 116. In the illustrated embodiment, policy manager module 118 is further operative to perform various other operations on the asset allocation fund module 116. The above described policy manager module 118 operations are discussed more fully herein.

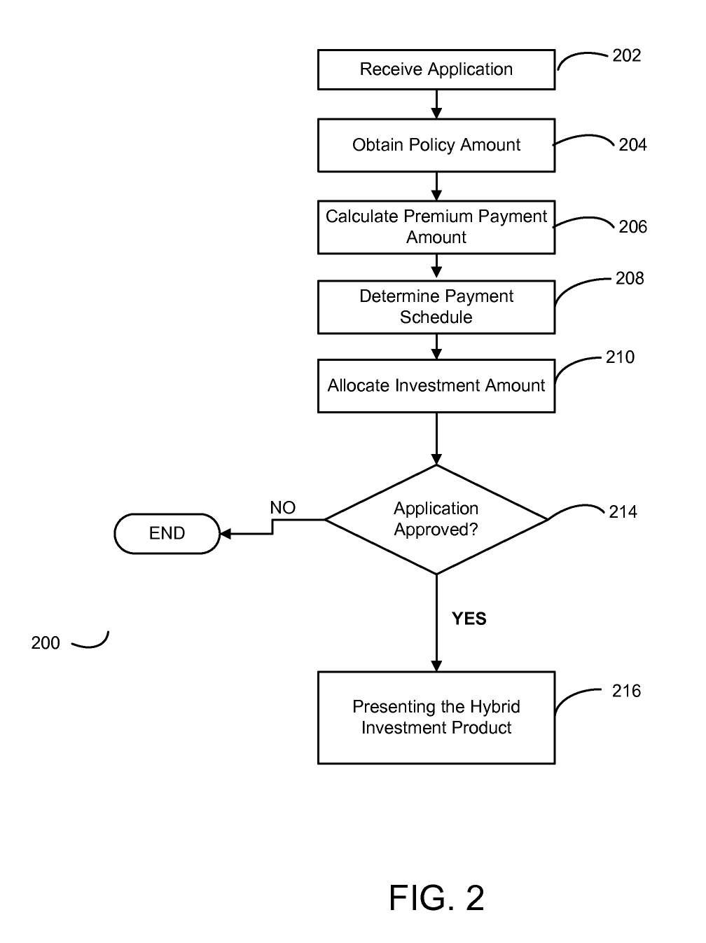

FIG. 2 illustrates a further embodiment of the present invention, describing a method for providing a hybrid life insurance and non-life insurance investment product, such as a mutual or investment fund, for an individual with, in this particular embodiment, a premium funding vehicle. According to the embodiment that FIG. 2 illustrates, the method 200 begins upon receipt of data for acquiring a hybrid life insurance and non-life insurance investment product, such as an application for a custom whole life (CWL) policy and a mutual fund investment product, at step 202. In the illustrated embodiment, a potential insured submits a CWL application over a network, such as the Internet, to a life insurance provider. In alternative embodiment, a customer may visit an agent of the life insurance provider and fill out the application at the agent location. The agent may then submit the CWL application over a network, such as the Internet. At step 202, in an example, an initial investment amount for an investment product comprising a life insurance investment component and a non-life insurance investment component is obtained.

In the example embodiment, the method 200 then obtains a face amount of the life insurance investment component, step 204. In one embodiment, the method 200 analyzes the application to determine a recommended policy amount. For example, the method 200 may analyze the investment amount, the answers to various questions such as the potential investor's current age, current and past health conditions, investment preferences such as risk adversity or tolerance, or other data as may be relevant to insurance and investment decisions, to determine an appropriate amount of insurance as will be known to those of skill in the art. A recommendation may be provided as described in U.S. patent application Ser. No. 12/403,474. In an embodiment, when a potential insured submits an application, the potential insured indicates an amount to be invested. For example, the potential insured may identify that he will invest $100,000. In the embodiment, the method 200 may use this investment amount to calculate a percentage to allocate to a whole life insurance policy. For example, the method 200 may determine that a $25,000 whole life insurance policy is an appropriate insurance policy for a $100,000 investment. In alternative embodiments, the method 200 may be constrained to a pre-defined maximum and minimum insurance policy amount. For example, the method 200 may only choose a policy between $25,000 and $250,000. In other embodiments, the policy amount is selected by the prospective insured or investor.

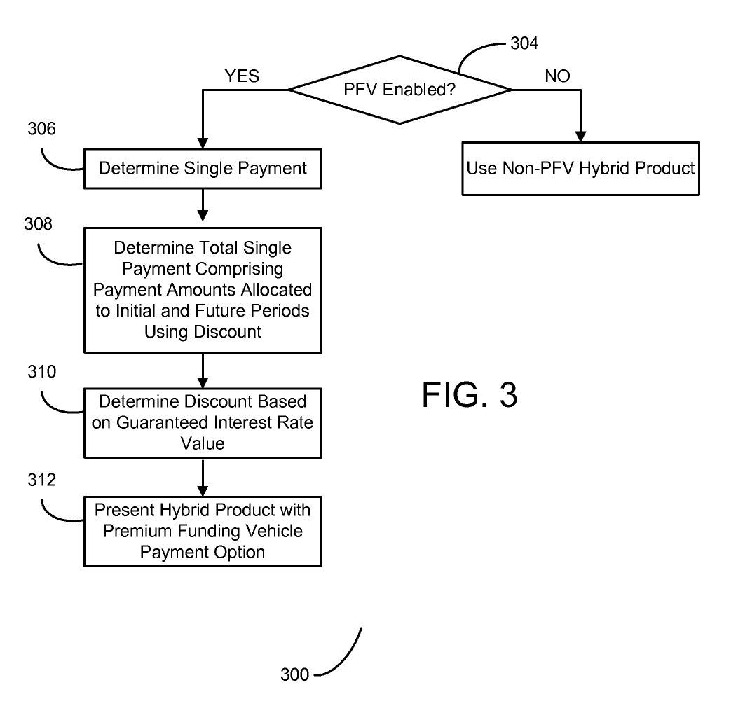

In an embodiment, once the method 200 obtains a face amount for the life insurance investment component, such as at step 204, the method 200 then calculates a premium payment amount, at step 206. In an embodiment, the premium payment amount is determined based on the face value of the selected insurance component. In another embodiment, the determination of the premium payment amount further includes a premium funding vehicle, such as previously described, or as illustrated in one example in FIG. 3, described below. In an embodiment, calculation of the premium payment amount further includes accounting for the nature of the policy to be provided, such as the nature of the issue (e.g., simplified issue) or nature of the underwriting (e.g., limited). In an example, the policy will be issued as a group certificate with limited underwriting and without requiring the prospective insured to undergo more comprehensive eligibility assessments. In such an example, the policy would not require an intensive health assessment and would only be available for applicants that qualify in certain risk classes, such as a standard or non-smoker risk class, for instance.

In the illustrated embodiment of method 200, after the premium payment amount for the insurance investment component is calculated at step 206, the method 200 determines a payment schedule for the premium payment amount at step 208. In an embodiment, the payment schedule is set to be a fixed premium payment period such as 12 years. Any variety of payment periods could be selected within the scope of the invention. In an embodiment, the payment period will be fixed and cannot be extended or shortened. In other embodiments, variations to the payment period are permitted. In an embodiment, the payment schedule for the premium payment amount comprises a single payment. In a further embodiment wherein a premium funding vehicle is utilized, such as previously described, or as illustrated in one example in FIG. 3, described below, the single payment is allocated towards payment of a portion the premium payment amount for an initial period of time and payment of another portion of the premium payment amount for a further or future period of time.

In the embodiment illustrated in FIG. 2, the method further includes allocating a portion of the initial investment amount to the life insurance investment component and allocating a portion of the initial investment amount to the non-life insurance investment component, shown at step 210. In some embodiments, the allocating of the initial investment amount is based at least in part on the data obtained in the prospective insured's application, the obtained faced amount of the life insurance investment component, the calculated premium payment amount and the determined payment schedule, or any combination of the foregoing.

In the embodiment illustrated in FIG. 2, the method further includes determining whether the application for the hybrid investment product is approved at step 214. If the application is not approved, the process ends at step 214. If the application is approved, the method continues to step 216. At step 216, the provider of the hybrid investment product presents a combined investment product for an individual comprising a life insurance investment component and a non-life insurance investment component. In an embodiment, the step of presenting is based at least in part on the allocations of the initial investment amount to the life insurance investment component and to the non-life insurance investment component, the premium payment amount and the payment schedule.

In a further embodiment, illustrated by FIG. 3, a method is described for providing a hybrid investment product with a premium funding vehicle (PFV) component. As the embodiment of FIG. 3 illustrates, at step 304 it is determined whether a premium funding vehicle is available for the hybrid investment product to be presented. If no, premium payments will be made without use of a premium funding vehicle, such as in examples previously described or in other manners as will be understood by those of skill in the art. If yes, the example embodiment determines that the payment schedule for the premium payment amount for the prospective insured will comprise a single payment, at step 306. In some embodiments, the method continues to step 308, where it is determined that the single payment of the premium payment amount will comprise a payment amount for an initial period of time and a payment amount for a future period of time calculated based on a discounted present value of future premium payments. In the same or an alternative embodiment, the premium payment amount is calculated with a discount to be applied to the premium payment amount based at least in part on a guaranteed interest value, as shown in the example of step 310. At step 312, a hybrid investment product as is contemplated in one embodiment of the present invention is presented with a premium funding vehicle payment option.

By way of further illustration, in an embodiment a prospective insured or investor selects a hybrid investment product with a premium funding vehicle. In this example, the investment product will call for the investor to pay a single payment representing the first year of premium required for the insurance policy as well as the premium required for the remaining years that payment will need to be made. However, the amount of premium required for the remaining years after the first year will be reduced, or discounted, based on a guaranteed interest rate to be applied to the portion of the single payment designated for the payment years after the first year. For instance, if the premium for a life insurance policy with a face value of $25,000 is $24,000 without the premium funding vehicle, with premiums to be paid $2,000 each year, when the premium funding vehicle is implemented the insured will pay a total of $20,500 in a single payment to obtain the life insurance policy with the face value of $25,000, achieving a savings, in this example, of $3,500. The $20,500 is applied to the first year premium of $2,000, and the remainder of $18,500 is applied to the premium funding vehicle fund to meet the premium payments for the next eleven years of premium payments required. The savings is achieved because the payment designated to the premium funding vehicle fund will earn a guaranteed interest rate for the period that premium payments will be due, in an example, a 3% rate of interest. Thus, in an embodiment, the portion of the single payment allocated to the premium funding vehicle is held in the premium funding vehicle fund, accrues interest, and is applied to the payment of the premiums for the life insurance component when those premiums become due, which may be on an annual basis.

In some embodiments, the hybrid investment product provides that the interest rates which apply to the premium funding vehicle will be higher than the guaranteed rate used to discount the future premium payments. In such an embodiment, the interest earned may be paid to the investor or insured or allocated to the non-life insurance investment component or to fees or the like. In the same or alternative embodiments, the additional interest earned may be paid out annually or at some other interval, or may be held until the end of the premium payment period and then disbursed.

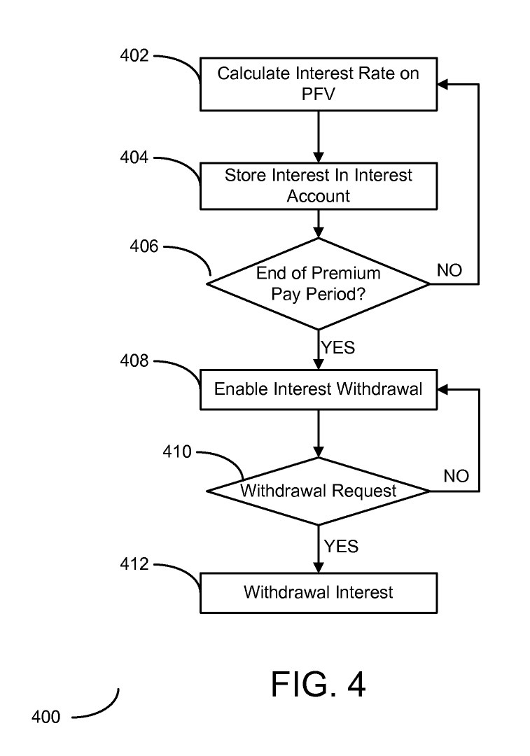

FIG. 4 illustrates an example of a method for providing a hybrid investment product in accordance with one embodiment of the invention, describing details concerning an aspect of the product to be presented. In an example, the investment product to be presented provides for processing an interest withdrawal from a premium funding vehicle. As the embodiment of FIG. 4 illustrates, a method 400 calculates an interest rate for funds stored in a PFV, step 402. In the illustrated embodiment, the method 400 utilizes a fixed interest rate determined at the time of account creation. For example, the PFV may have a 3% fixed interest rate for a given year in the premium pay-period. In other embodiments, the interest rate is variable, or a combination such as fixed guaranteed rate and variable for any interest above the guaranteed rate.

In an embodiment, after determining a recommended insurance policy face value, the method calculates a present value premium total, such as discussed with reference to step 204 of FIG. 2. In the embodiment under discussion, the present value premium total represents a present value equal to the total premium amount that will be paid to pay up the whole life insurance. For example, the method may identify the length of the whole life insurance premium pay-period and divide the policy face value by the length of the premium payment period. In an alternative embodiment, the prospective insured may have an option to choose a premium payment period, which in some cases is subject to constraints determined by the insurance policy. Additionally, the method or system may discount the premium amount based on a fixed or variable interest rate. Furthermore, in some embodiments, the method subtracts the premium for the first year before making the calculation. For example, after the method determines the face value is $25,000 and the total premium is $24,000, the method deducts $2,000 as the amount which will be paid by the prospective insured for the premium payment for the first year. At that point, the remaining balance of the premium for the face value is $22,000. The method then determines that the remaining premium payment period is 11 years. The method calculates the amount of present value funds needed to pay the remaining premiums for the remaining 11 years of payment period. For example, the method determines that a value of $18,500 is needed to pay the premiums for the remaining 11 years of premiums by applying a guaranteed interest rate to the $18,500 which will cover the premium costs until the policy is paid up. In the example, the total amount of present value funds required for the $25,000 face value policy is $20,500, which reflects the interest accrued by the present value premium total during the lifetime of the premium payment period or another time frame as may be used in other embodiments. In some embodiments, the insured is permitted to change from annual payments to a PFV payment method during the premium payment term. For example, at each anniversary of the policy during the first 5 years of the premium payment period, the insured would have the option to provide the then calculated present value of future premium payments, discounted based on a guaranteed interest rate. In an embodiment, the guaranteed interest rate declines each year into the premium payment period (e.g., 3% in year 1, 2.5% in year 2 and so on). In other embodiments, the present value of the total future premium payments, applying a guaranteed interest rate to the total, is calculated to include the first year premium payment amount. In a still further embodiment, the insured is permitted to opt out from a previously selected PFV method to make direct payment of the premiums annually. In such a case, the PFV account value at the opt-out date is remitted to the insured and from that point forward the insured is directly responsible for the full value of the premium payments as they become due.

Returning to the example embodiment of FIG. 4, at step 404, the method 400 calculates the interest accrued on the PFV account and stores the interest. In one embodiment, the interest accumulated on the present value premium payment is credited monthly and is stored in a separate account from the present value premium payment made by the insured or investor. In alternative embodiments, the interest is credited at different time intervals and is stored in the same PFV fund account, while a record of the applied interest and the principal premium payment amount is stored separately. In still further embodiments, the funds accumulated under the guaranteed interest rate is stored in the PFV account, while funds accumulated above the guaranteed interest rate are stored separately, such as by deposit into the non-life insurance investment component account, allocated in a manner previously determined, such as 60% equities and 40% fixed income. It will be understood by those of skill in the art that variations on the foregoing can be made within the scope of the present invention.

In the example of FIG. 4, the method 400 determines if the premium payment period has concluded, e.g., after 12 years of payments have been applied from the PFV account, at step 406. If the end of the premium payment period has not been reached, in the illustrated embodiment, the method 400 continues to accumulate interest on the PFV amount. If the premium payment period has concluded, the method enables the withdrawal of interest, at step 408. In the illustrated embodiment, enabling the withdrawal of PFV interest comprises updating an investor or insured account to indicate that the investor may withdraw the remaining interest of the PFV after the insurance policy has been paid in full. Alternatively, or in conjunction with the foregoing, the method 400 may transmit a notification to the investor or insured that the PFV interest is available for withdrawal. In the embodiment of FIG. 4, the interest accrued on the PFV account is only available for withdrawal after the life insurance policy has been paid in full, ensuring that funds are available to be paid to the premiums on the life insurance policy as they become due.

After enabling the interest withdrawal, the method 400 stores the interest and determines if request to withdraw or transfer the interest is made, at step 410. If the insured wishes to withdraw the interest, the method 400 withdraws the interest and transmits the PFV interest funds to the insured, step 412. If the method 400 does not receive the request, the method 400 continues to store the interest amount with further accrual. In one embodiment, the accumulated interest is automatically transferred to the non-life insurance component, and the PFV account is closed.

FIGS. 1-4 are conceptual illustrations allowing an explanation of the present invention. It should be understood that various aspects of the embodiments of the present invention could be implemented in hardware, firmware, software, or a combination thereof. In such an embodiment, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms machine readable medium, computer program medium, and computer usable medium are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to the embodiments described. Other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, it is not intended for any term in the specification or claims to be ascribed an uncommon or special meaning unless explicitly set forth as such. Further, the present invention encompasses present and future known equivalents to the known components referred to herein by way of illustration.

While the invention has been described and illustrated in connection with various embodiments, many variations and modifications as to be evident to those of skill in the relevant art(s) may be made without departing from the spirit and scope of the invention, and the invention is thus not to be limited to the precise details of methodology or construction set forth above, as such variations and modifications are intended to be included within the scope of the invention. It is to be understood by those of ordinary skill in the relevant art(s) that the various data processing tasks described herein may be implemented in a wide variety of ways, many of which are known and many more of which are doubtless to be hereafter developed. For example, a wide variety of computer programs and languages are now known, and are likely to be developed, which are suitable for storing, accessing, and processing data, as well as for performing, processing, and using actuarial forecasts and other analyses as disclosed herein. Except to the extent necessary or inherent in the processes themselves, no particular order to steps or stages of methods or processes described in this disclosure, including the figures, is implied. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). Thus, the present invention should not be limited by any of the above-described exemplary embodiments, but should be defined only in accordance with the following claims and their equivalents.

We claim:

1. A computer implemented method of providing a hybrid life insurance and non-life insurance investment product for an individual, comprising:
obtaining an initial investment amount for an investment product comprising a life insurance investment component and a non-life insurance investment component;
obtaining a face amount of the life insurance investment component;
electronically calculating, using a processing device, a premium payment amount for the life insurance investment component;
determining a payment schedule for the premium payment amount;
allocating a portion of the initial investment amount to the life insurance investment component;
allocating a portion of the initial investment amount to the non-life insurance investment component;
presenting, based at least in part on the allocations of the initial investment amount to the life insurance investment component and to the non-life insurance investment component, the premium payment amount and the payment schedule, the life insurance investment component and the non-life insurance investment component as a combined investment product for an individual in a singular transaction.

2. The computer implemented method of claim 1, wherein the payment schedule for the premium payment amount comprises a single payment.

3. The computer implemented method of claim 2, wherein the single payment of the premium payment amount represents a payment amount for an initial period of time and a payment amount for a future period of time calculated based on a discounted present value of future premium payments.

4. The computer implemented method of claim 2, wherein the electronically calculating the premium payment amount further comprises calculating a discount to be applied to the premium payment amount based at least in part on a guaranteed interest value applied to the single payment.

5. The computer implemented method of claim 4, comprising allocating the single payment to a premium funding vehicle that provides a return greater than the guaranteed interest value and paying the return above the guaranteed interest value to the individual.

6. The computer implemented method of claim 5, wherein paying the return above the guaranteed interest value to the individual comprises allocating the return above the guaranteed interest value to the individual to the non-life insurance investment component.

7. The computer implemented method of claim 1, wherein the life insurance investment component comprises a life insurance group certificate.

8. The computer implemented method of claim 1, wherein obtaining an initial investment amount comprises receiving from the individual an amount for the initial investment and an amount for allocating the portion of the initial investment, and wherein the initial investment amount is allocated between the life insurance investment component and the non-life insurance investment component according to the amount for the allocation specified by the individual.

9. The computer implemented method of claim 8, wherein the non-life insurance investment component comprises a fund, the method further comprising receiving from the individual an amount for allocating the non-life insurance investment portion of the initial investment between asset types, and allocating the non-life insurance investment portion of the initial investment between the individual specified asset types.

10. A system for providing a hybrid life insurance and non-life insurance investment product for an individual, comprising:
a user interface effective to obtain an initial investment amount for an investment product comprising a life insurance investment component and a non-life insurance investment component and a face amount of the life insurance investment component;
a data storage device operative with the user interface and effective to store the initial investment amount for an investment product comprising a life insurance investment component and a non-life insurance investment component, a face amount of the life insurance investment component, data representing an allocated portion of the initial investment amount allocated to the life insurance investment component and an allocated portion of the initial investment amount allocated to the non-life insurance investment component, a premium payment amount and a payment schedule;
a processor operable with the user interface and data storage device to calculate a premium payment amount for the life insurance investment component, determine a payment schedule for the premium payment amount, allocate a portion of the initial investment amount to the life insurance investment component, allocate a portion of the initial investment amount to the non-life insurance investment component, and present the life insurance investment component and the non-life insurance investment component as a combined investment product for an individual in a singular transaction.

11. The system of claim 10, wherein the processor is operable to calculate the payment schedule as a single payment.

12. The system of claim 11, wherein the single payment represents a payment amount for an initial period of time and a payment amount for a future period of time calculated based on a discounted present value of future premium payments.

13. The system of claim 11, wherein the processor is operable to calculate a discount to be applied to the premium payment amount based at least in part on a guaranteed interest value applied to the single payment.

14. The system of claim 13, wherein the processor is operable to allocate the single payment to a premium funding vehicle that provides a return greater than the guaranteed interest value and to pay the return above the guaranteed interest value to the individual.

15. The system of claim 13, wherein the processor is operable to allocate the single payment to a premium funding vehicle that provides a return greater than the guaranteed interest value and to allocate the return above the guaranteed interest value to the non-life insurance investment component.

16. The system of claim 10, wherein the life insurance investment component comprises a life insurance group certificate.

17. The system of claim 10, wherein the initial investment amount and an amount for allocating the portion of the initial investment between the life insurance investment component and the non-life insurance investment component are obtained from the individual, and wherein the processor is operable to allocate the initial investment amount according to the amount of the allocation specified by the individual.

18. The system of claim 17, wherein the non-life insurance investment component comprises a fund, and wherein the processor is operable to receive from the individual an amount for allocating the non-life insurance investment portion of the initial investment between asset types, and to allocate the non-life insurance investment portion of the initial investment between the individual specified asset types

19. A computer implemented method of providing a hybrid life insurance and non-life insurance investment product for an individual, comprising:
obtaining from an individual an initial investment amount for an investment product comprising a life insurance investment component and a non-life insurance investment component, a face amount of the life insurance investment component, and an amount for allocating the non-life insurance investment portion of the initial investment between asset types;
electronically calculating, using a processing device, a premium payment amount for the life insurance investment component payable in a single payment and a discount to be applied to the premium payment amount based at least in part on a guaranteed interest value applied to the single payment;
allocating the initial investment amount between the life insurance investment component and the non-life insurance investment component according to the allocation amount specified individual;
allocating the non-life insurance investment portion of the initial investment between the individual specified asset types;
presenting, based at least in part on the allocations of the initial investment amount to the life insurance investment component and to the non-life insurance investment component, the premium payment amount, the life insurance investment component and the non-life insurance investment component as a combined investment product for the individual in a singular transaction.

20. The computer implemented method of claim 19, comprising allocating the single payment to a premium funding vehicle that provides a return greater than the guaranteed interest value and paying the return above the guaranteed interest value to the individual.

21. The computer implemented method of claim 20, wherein paying the return above the guaranteed interest value to the individual comprises allocating the return above the guaranteed interest value to the individual to the non-life insurance investment component.
